(19) United States
(12) Patent Application Publication
(10) Pub. No.: US 2024/0137839 A1
(43) Pub. Date: Apr. 25, 2024

(54) METHOD AND APPARATUS FOR CONNECTING MULTIPLE DEVICES USING MESH NETWORK

(71) Applicants: Kevin Kyong Cho, Pleasanton, CA (US); Alexander David Stonard, San Francisco, CA (US)

(72) Inventors: Kevin Kyong Cho, Pleasanton, CA (US); Alexander David Stonard, San Francisco, CA (US)

(21) Appl. No.: 18/382,474

(22) Filed: Oct. 19, 2023

Related U.S. Application Data
(60) Provisional application No. 63/417,689, filed on Oct. 20, 2022.

(51) Int. Cl. H04W 40/24; H04W 12/041

(52) U.S. Cl. CPC H04W 40/24; H04W 12/041; H04W 84/18

(57) ABSTRACT

In a method for connecting a plurality of devices for a wireless mesh communication network, a first device becomes a leader device for the wireless mesh communication network, where the leader device manages the plurality of devices and the wireless mesh communication network, a second device becomes a first node device by an onboarding process, where the second device becomes the first node device within the wireless mesh communication network of the leader device, and a third device becomes a second node device by the onboarding process, where the third device becomes the second node device within the wireless mesh communication network. A secure digital key is created at the first device for the second and the third devices to wirelessly communicate with the second device and the third devices securely. The first device wirelessly communicates with the second device, either directly or through the third device.

### CLAIM FOR PRIORITY

This application claims the benefit of priority under 35 U.S.C. § 119(e) to U.S. Provisional Application Ser. No. 63/417,689 filed on Oct. 20, 2022, the disclosure of which is incorporated herein by reference in its entirety.

### BACKGROUND

The measurement and evaluation of indoor air quality have improved over time. For instance, an increasing number of air quality monitoring devices that have a number of features as well as relatively compact sizes are becoming more readily available. The air quality monitoring devices typically measure the conditions inside of a space, such as a residential, commercial, or industrial environment. The measured conditions may be evaluated to determine whether the conditions are at healthy and/or comfortable levels and modifications to the conditions, such as temperature and humidity, may be made based upon the outcome of the evaluated conditions. When multiple air quality monitoring devices within the same air quality monitoring network are installed and placed in a large space, such as a high-rise commercial building, and a large factory space, or in a complex of multiple buildings, a quality and security of data communication between and among the devices within the same network are problematic and unstable.

### BRIEF DESCRIPTION OF THE DRAWINGS

Features of the present disclosure are illustrated by way of example and not limited in the following figure(s), in which like numerals indicate like elements, in which:

FIG. 1 shows a simplified diagram of an example long-distance wireless mesh communication network within which example devices may be implemented;

FIG. 2 depicts a simplified block diagram of a computing device within a network, according to an example;

FIG. 3 shows a structure housing multiple devices depicted in FIG. 1, according to an example; and

FIG. 4 illustrates a simplified diagram of an example long-distance wireless mesh communication network depicted in FIG. 1, according to an example.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein is a method for connecting multiple devices using mesh network. Also disclosed herein is a computing device that may implement the method and a machine readable storage medium on which instructions for the method may be stored. More particularly, disclosed herein are a method and an apparatus for connecting multiple devices using a long-distance wireless mesh communication protocol for communicating sensor data. The method disclosed herein may include configuring a first device to become a leader device for the wireless mesh communication network, configuring a second device to become a first node device by an onboarding process, creating a secure and unique digital key for the second device to wirelessly communicate with the second device, and sending and receiving data between the first device and the second device.

The second device becomes the first node device within the wireless mesh communication network of the leader device. The leader device manages the multiple devices including the multiple node devices, and the wireless mesh communication network. The leader device and each of the multiple node devices may include a sensor device. The sensor device may include an environmental condition monitoring sensor, such as a CO2 sensor, a dust sensor, a toxic chemical sensor, a temperature sensor, and a humidity sensor. Therefore, the leader device and each of the multiple node devices may be an environmental condition monitoring device.

An environmental condition monitoring device may monitor environmental conditions in the structure and may communicate the environmental condition data pertaining to the monitored conditions to the computing device via the leader device and the multiple node devices. In addition, the computing device may analyze and process the received environmental data to determine, for instance, how conditions in the structure are to be manipulated to achieve a desired goal. The desired goal may be, for instance, conditions that meet a user's preferences. Moreover, the computing device output instructions to an environmental condition modifying device to modify the environmental conditions according to the determined manipulation. The leader device may be either a computing device or an environmental condition modifying device. The leader device may has an has an internet connection via an Ethernet or a Wi-Fi router.

To configure the first device to the leader device, the method disclosed herein may also include turning on a switch on the leader device for a preset duration, such as 5 second or 10 second, etc. For the onboarding process, after the first device became a leader device, the switch on the leader device may be turned on by pressing the switch for a second preset duration to turn on the data communication channel of the leader device. Here, the second preset duration may be shorter than the preset turning on duration for setting a leader device, such as 1 second or 2 second. After turning on the data communication channel of the leader device, a user places the second device in a close proximity to the leader device to configure the second device to become a first node device within the wireless mesh communication network of the leader device.

The method disclosed herein may also include configuring a third device to a second node device by the onboarding process disclosed above. By the onboarding process disclosed above, the third device becomes the second node device within the wireless mesh communication network of the leader device. The leader device wirelessly communicates with each of the first node device and the second node device within the wireless mesh communication network of the leader device. The first node device and the second node device may wirelessly communicate with each other. The leader device may wirelessly communicate with the first node device, either directly or through the second node device, and the leader device may wirelessly communicate with the second node device, either directly or through the first node device. By the onboarding process disclosed above, multiple devices may become multiple node devices within the wireless mesh communication network of the leader device.

There are no limitations of number of node devices within the wireless mesh communication network of the leader device. When there are more than two node devices, the leader device may wirelessly communicate with any of the node devices, either directly or through any number of the other node devices. In one embodiment, when the leader device and the multiple node devices wirelessly communicate with each other, the leader device and each of the multiple node devices find and communicate with a device within the closest distance. For instance, when the first node device is located closer to the second node device than the leader device, the second node device may wirelessly communicate with the leader device via the first node device. However, if the first node device is not available, because the electric power is failed on the first node device for example, the second node device may wirelessly communicate with the leader device directly.

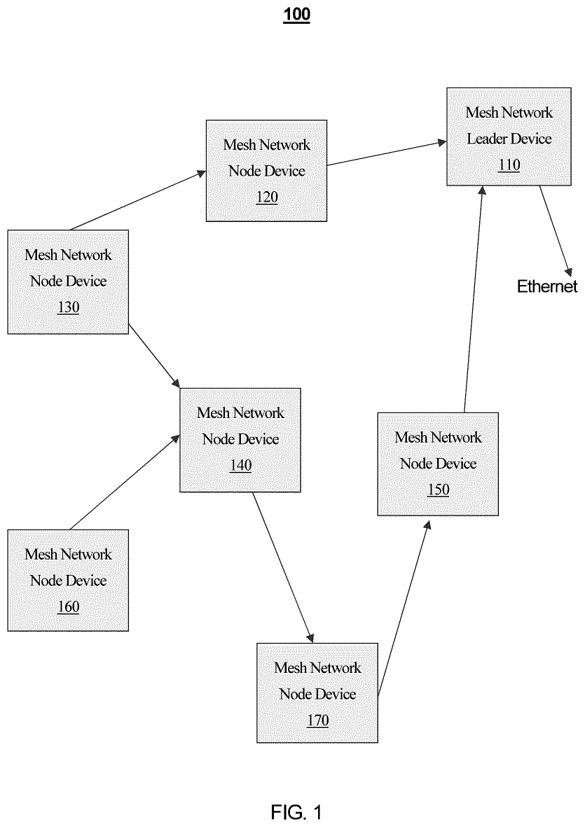

With reference first to FIG. 1, there is shown a simplified diagram of an example long-distance wireless mesh communication network 100 within which an example leader device 110 and multiple node devices 120-170 may be implemented for communicating sensor data. It should be understood that the example long-distance wireless mesh communication network 100 depicted in FIG. 1 may include additional components and that some of the components described herein may be removed and/or modified without departing from the scope of the long-distance wireless mesh communication network 100.

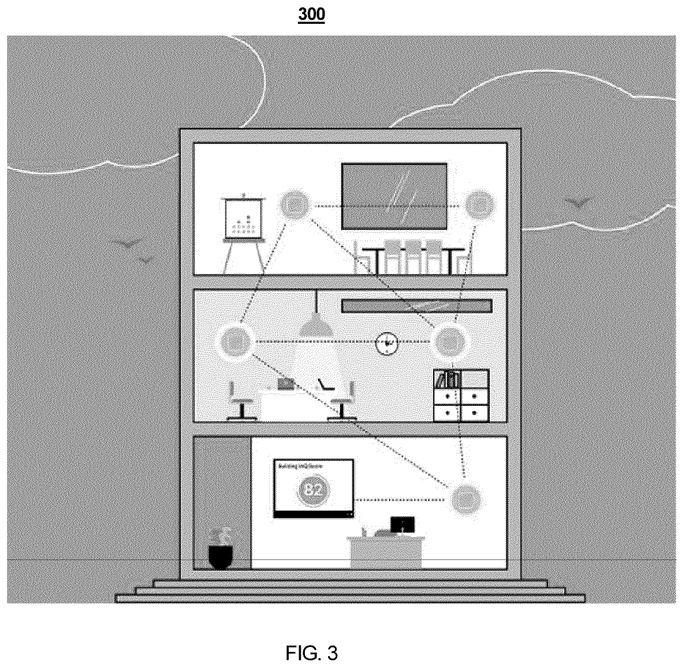

The long-distance wireless mesh communication network 100 is depicted as including a leader device 110, and node devices 120, 130, 140, 150, 160, and 170. The leader device 110, and the node devices 120, 130, 140, 150, 160, and 170 are shown as being positioned within a structure 300 as shown in FIG. 3. FIG. 3 shows a structure housing multiple devices depicted in FIG. 1. The structure 300 may be an indoor structure such as a room in a house, an office in an office building, a gym, a warehouse, or the like. The structure 300 may also be an entire house, office building, etc. According to an example, the leader device 110 and each of the node devices 120, 130, 140, 150, 160, and 170 may detect one or more environmental conditions, such as temperature, humidity, carbon dioxide concentration, volatile organic compounds, dust, etc., inside the structure 300. Each of the node devices 120, 130, 140, 150, 160, and 170 may communicate environmental data pertaining to the detected environmental condition(s) to the leader device 110.

Each of the node devices 120, 130, 140, 150, 160, and 170 may also modify one or more of the environmental conditions detected by the each of the other node devices 120, 130, 140, 150, 160, and 170. For instance, each of the node devices 120, 130, 140, 150, 160, and 170 may be an air condition system, a humidifier, a de-humidifier, an air purifier, a heating system, a fan, an actuator for a window, a ventilation system, etc. In other examples, each of the node devices 120, 130, 140, 150, 160, and 170 may also include other types of devices, such as lights, doors, network connected devices, etc.

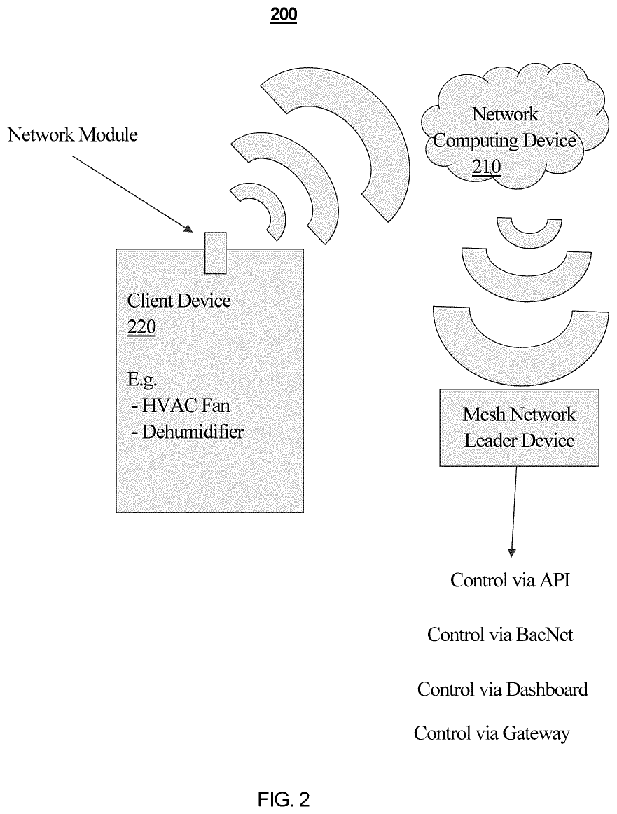

FIG. 2 depicts a simplified block diagram of the network 200 and the computing device 210, according to an example. As shown in FIG. 2, the computing device 210 may be external to the structure 300 and may communicate with the node devices 120, 130, 140, 150, 160, and 170 via the leader device 110 within the long-distance wireless mesh communication network 100. The computing device 210 may also communicate with the client device 220 via the network 200. In addition, or alternatively, the computing device 210 may communicate with the client device 220 through the leader device 110. In this example, the network computing device 210 may communicate instructions for the client device 220 via the network 200 and the leader device 110, and the node devices 120, 130, 140, 150, 160, and 170.

The network 200 may be the Internet, an Intranet, a Wide Area Network, or the like. In any regard, the network computing device 210, which may be a server computer that communicates with the leader device 110, and the node devices 120, 130, 140, 150, 160, and 170, may receive the environmental conditions from the leader device 110, and the node devices 120, 130, 140, 150, 160, and 170, acting as an environmental condition monitoring device(s) and may store the received environmental conditions in a data store (not shown). For instance, the computing device 110 may store the received environmental conditions in databases on the data store. Additionally, although a single computing device 210 has been shown in FIG. 2, it should be understood that multiple computing devices, e.g., servers may implement the features of the computing device 210 discussed herein. By way of example, a first computing device (e.g., first server) may receive the environmental conditions and may forward the received environmental conditions to a second computing device (e.g., second server) and the second computing device may analyze the received environmental conditions.

In any regard, the computing device 210 may analyze the environmental data received from the leader device 110, and the node devices 120, 130, 140, 150, 160, and 170 to determine, for instance, an environmental condition management operation with respect to the environmental conditions in the structure. For instance, the computing device 210 may determine whether the environmental conditions within the structure 300 are within desirable ranges or if the conditions are abnormal, e.g., outside of predetermined ranges. In response to a determination that the environmental conditions within the structure 300 are abnormal, the computing device 210 may output an instruction to the client device 220 to modify an appropriate environmental condition.

According to an example, each of the leader device 110, and the node devices 120, 130, 140, 150, 160, and 170 may be a standalone device that is to be placed in a location within the structure 300 at which environmental conditions are to be monitored. In another example, the leader device 110, and the node devices 120, 130, 140, 150, 160, and 170 may be a wearable device that a user may wear. In a further example, the leader device 110, and the node devices 120, 130, 140, 150, 160, and 170 may communicate with a wearable device (not shown), which may be an electronic device that may be worn on a user's wrist or elsewhere on a user's body or clothing. In this example, the leader device 110, and the node devices 120, 130, 140, 150, 160, and 170 may communicate data to the wearable device. In addition or alternatively, a user may control the leader device 110, and the node devices 120, 130, 140, 150, 160, and 170 through the wearable device.

In one example, the computing device 210 is a server computer. In other examples, the computing device 210 may be other types of computing devices, such as, a personal computer, a laptop computer, a smartphone, a tablet computer, or the like.

The computing device 210 is shown in FIG. 2 as including a hardware processor and a data store. The hardware processor may be a semiconductor-based microprocessor, a central processing unit (CPU), an application specific integrated circuit (ASIC), and/or other hardware device. The data store may be a Random Access Memory (RAM), an Electrically Erasable Programmable Read-Only Memory (EEPROM), a storage device, an optical disc, or the like. In addition, the data store may store, for instance, environmental data received from one or more of the leader device 110, and the node devices 120, 130, 140, 150, 160, and 170, data pertaining to the structure 300 or structures within which the one or more of the leader device 110, and the node devices 120, 130, 140, 150, 160, and 170 are located, information regarding the users of the one or more of the leader device 110, and the node devices 120, 130, 140, 150, 160, and 170, and the like.

The computing device 210 is also depicted as including a machine readable storage medium on which is stored machine readable instructions that the hardware processor may execute. More particularly, the hardware processor may fetch, decode, and execute the instructions to receive environmental data, compute a score corresponding to the received environmental data, determine an environmental condition management operation, determine length of exposure of a user device, predict a future score, manage a user preference, output an instruction, predict occupancy in a structure, and calculate environmental conditions in another structure. As an alternative or in addition to retrieving and executing instructions, the hardware processor may include one or more electronic circuits that include electronic components for performing the functionalities of the instructions. In any regard, the hardware processor may communicate instruction signals to either or all of the leader device 110, and the node devices 120, 130, 140, 150, 160, and 170 and the client device 220.

The machine-readable storage medium may be any electronic, magnetic, optical, or other physical storage device that contains or stores executable instructions. Thus, the machine-readable storage medium may be, for example, Random Access Memory (RAM), an Electrically Erasable Programmable Read-Only Memory (EEPROM), a storage device, an optical disc, and the like. The machine-readable storage medium may be a non-transitory machine-readable storage medium, where the term “non-transitory” does not encompass transitory propagating signals.

According to an example, the computing device 210 may include a plurality of hardware processors and/or a hardware processor containing a plurality of cores. In these examples, each the plural hardware processors and/or cores may operate in parallel, i.e., use parallel processing techniques to analyze environmental data received from respective ones of multiple environmental condition monitoring devices. In this regard, the use of multiple hardware processors and/or cores may reduce the amount of time required to receive, analyze, and manage environmental condition data received from one or more of the leader device 110, and the node devices 120, 130, 140, 150, 160, and 170. In addition, the use of multiple hardware processors and/or cores may reduce the amount of time required to determine how the leader device 110, and the node devices 120, 130, 140, 150, 160, and 170 are to be manipulated as well as to manipulate the client device 220.

According to an example, the hardware processor may implement a subscription and publishing service for a plurality of environmental condition monitoring devices, for instance, to stream real-time information to distributed client devices via the network. In this example, the computing device 210 may handle a number of connections for streaming of real-time data from the leader device 110, and the node devices 120, 130, 140, 150, 160, and 170 as the data is stored to persistent storage, e.g., in the data store. In addition, the computing device 210 or another server may provide authentication services to handle the granting and revoking credentials of client devices required to access the streamed information. For instance, the computing device 210 may provide streaming data to authenticated client devices that subscribe to receive the streamed data.

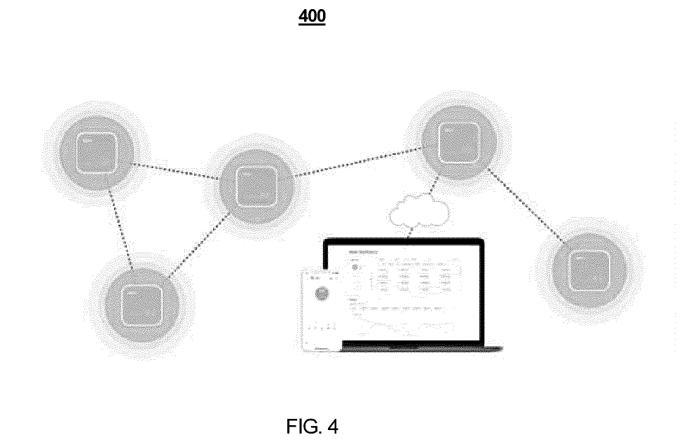

FIG. 4 illustrates a simplified diagram of an example long-distance wireless mesh communication network depicted in FIG. 1, according to an example.

Some or all of the operations set forth in the methods in this disclosure may be contained as utilities, programs, or subprograms, in any desired computer accessible medium. In addition, the methods may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for connecting a plurality of devices for a wireless mesh communication network, the method comprising:
configuring a first device to become a leader device for the wireless mesh communication network, wherein the leader device manages the plurality of devices and the wireless mesh communication network;
configuring, at the first device, a second device to become a first node device by an onboarding process, wherein the second device becomes the first node device within the wireless mesh communication network of the leader device;
creating, at the first device, a secure digital key for the second device to wirelessly communicate with the second device; and
sending and receiving data, at the first device, to and from the second device.

2. The method according to claim 1, further comprising:
turning on a switch on the first device for a first preset duration to configure the first device to become the leader device.

3. The method according to claim 1, wherein the onboarding process comprises turning on the switch on the first device for a second preset duration to turn on the data communication channel of the first device, and placing the second device in a close proximity to the first device to configure the second device to become the first node device within the wireless mesh communication network of the leader device.

4. The method according to claim 1, wherein the first device has an internet connection.

5. The method according to claim 1, wherein the first device and the second device are sensor devices.

6. The method according to claim 5, wherein each of the sensor devices is an environmental condition monitoring device.

7. The method according to claim 1, further comprising:
configuring, at the first device, a third device to become a second node device by the onboarding process, wherein the third device becomes the second node device within the wireless mesh communication network of the leader device.

8. The method according to claim 7, wherein the first device wirelessly communicates with each of the second device and the third device within the wireless mesh communication network of the leader device,
wherein the second device and the third device wirelessly communicate with each other, and
wherein the first device wirelessly communicates with the second device, either directly or through the third device, and
wherein the first device wirelessly communicates with the third device, either directly or through the second device.

9. The method according to claim 8, wherein, when the first device, the second device and the third device wirelessly communicates with each other, each of the first device, the second device and the third device finds and communicates with a device within the closest distance,
wherein, when the second device is located closer to the third device than the first device, the third device wirelessly communicates with the first device via the second device, and
wherein, when the second device is not available, the third device wirelessly communicates with the first device directly.
